(19) United States
(12) Patent Application Publication
(10) Pub. No.: US 2003/0058563 A1
(43) Pub. Date: Mar. 27, 2003

(54) SDRAM interface control system and method

(75) Inventors: Rodney Daniel Blake, Savage, MN (US); Allen Nicholas Kramer, Hudson, WI (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/183,102

(22) Filed: Jun. 26, 2002

Related U.S. Application Data
(60) Provisional application No. 60/325,338, filed on Sep. 27, 2001.

(51) Int. Cl. G11B 5/09

(52) U.S. Cl. 360/51

(57) ABSTRACT

Systems and methods of controlling the timing of a clock signal used to latch information from one or more memory modules, such as SDRAM modules. The invention relates to generating a latch or read clock signal that relates to the actual SDRAM control clock signal. The generated clock signal accounts for variances due to PVT and PCB trace lengths. In one embodiment, the generated clock signal is fed back from the SDRAM module. That is, the SDRAM control clock signal is conducted serially to the one or more SDRAM modules and then back to the controller. As such, the read clock signal is essentially the same as the SDRAM clock signal. However, the read clock signal is delayed before its return to the controller due to PVT and trace length issues. Importantly however, these delays are similar to the delays associated with the read line information, such that the controller has a significantly precise understanding of when the information on the read lines is available for latching into its buffers.

### RELATED APPLICATION

This application claims priority of U.S. provisional application Serial No. 60/325,338, titled SELF TIMED SDRAM INTERFACE, filed Sep. 27, 2001, which is incorporated herein by reference.

### FIELD OF THE INVENTION

The present invention relates to methods and systems for controlling clock signals used in conjunction with memory devices. More particularly, the present invention relates to methods and systems for controlling timing signals used to read information from memory devices such as synchronous dynamic random access memory (SDRAM) modules.

### BACKGROUND OF THE INVENTION

Many computer and other microprocessor-based systems incorporate synchronous dynamic random access memory (SDRAM) modules for increased performance. Indeed, the popularity of SDRAM has increased such that now many different devices include SDRAM modules, such as laptop computers, printers, disc drive systems and tape drive systems, among others. In general, SDRAM modules are DRAM modules that are synchronized to a system clock that controls the microprocessor for the system. Synchronizing the SDRAM modules in this manner provides many benefits. For instance, it is well known that since the clock that controls the microprocessor also controls the SDRAM, wait states may be reduced or eliminated thereby improving data retrieval times.

SDRAM modules typically operate in conjunction with a controller, wherein the controller provides many functions, including supplying the clock signal to the SDRAM modules that ultimately controls the timing of the SDRAM modules. Further, the controller typically controls the conduction of other signals, such as address and data signals to the SDRAM modules. In order to control the conduction of address and data signals, the controller uses a series of latches and buffers for latching actual data and address information on to data and address lines connected to the SDRAM modules. Since the controller controls timing of the signals on the data and address lines, the controller is able to also supply clock signals to the SDRAM modules in accordance with the timing of the data and address signals to ensure proper operation of the SDRAM modules.

Given the synchronous nature of the SDRAM modules, the information read from the modules is also done using the system clock as a reference. Importantly however, each SDRAM module has specific timing constraints by which the controller must operate. For instance, the SDRAM module provides that following a rising edge of a control clock, during a read operation, that the data on the read lines will be available some predetermined time following that rising edge. In order to latch the information into the controller's buffers, there are also some setup and hold timing requirements relating to the time periods in which the information on the read lines must be stable before the clock signal used to latch the information is supplied to the latches. As an example, some SDRAM modules guarantee that the information on the read lines will not be stable for up to four nanoseconds following the rising edge of the clock. The SDRAM module may further guarantee that the information on the read lines will not change for two nanoseconds following a rising edge as well.

Prior art clock systems operated at frequencies that had approximately seven or more nanosecond cycles. Consequently, a controller reading information from an SDRAM module had approximately five or more nanoseconds to latch the read information into its buffers (three nanoseconds before the next rising edge plus two nanoseconds following the rising edge.) In such a system, the use of the system clock was sufficient to latch the information into the buffers without additional control.

As microprocessor technology improves, however, system clock rates are significantly increasing. Unfortunately, as the system clock speed increases, the time between rising edges of the clock signal decreases which introduces new problems associated with the SDRAM clock signals vis a vis reading information from the SDRAM modules. As an example, systems operating at 200 MHz have only five nanoseconds between rising edges of the clock signal. As the window of time between rising edges of the clock signal decreases the controller has a smaller window to latch the information into the read buffers. The problem becomes significant when delays in clock signal occur due to relatively uncontrollable or predictable conditions, such as process, voltage and temperature (PVT), printed circuit board (PCB) trace lengths, among other variance conditions. These delays reduce the confidence in the predicted timing of the actual SDRAM clock signal, i.e., when the rising edge actually occurs at the SDRAM module, which defines the window of time to read the data. Consequently, using the system clock signal to latch the information from the read lines is not adequate at higher clock speeds.

It is with respect to these and other considerations that the present invention has been made.

### SUMMARY OF THE INVENTION

The present invention relates to systems and methods of controlling the timing of a clock signal used to latch information from one or more memory modules, such as SDRAM modules. The system and method relates to generating a latch or read clock signal that relates to the actual SDRAM control clock signal. The generated clock signal accounts for variances due to PVT and PCB trace lengths. In one embodiment, the generated clock signal is fed back from the SDRAM module. That is, the SDRAM control clock signal is conducted serially to the one or more SDRAM modules and then back to the controller. As such, the read clock signal is essentially the same as the SDRAM clock signal. However, the read clock signal is delayed before its return to the controller due to PVT and trace length issues. Importantly however, these delays are similar to the delays associated with the read line information, such that the controller has a significantly precise understanding of when the information on the read lines is available for latching into its buffers.

In accordance with a particular embodiment, the present invention relates to a memory controller for latching information from one or more memory modules. The controller has one or more receive elements operably connected to the at least one memory modules for receiving read data from the at least one memory modules. Additionally, the controller also has a memory clock signal generator for generating a clock signal to control timing characteristics of the at least one memory module and a read clock signal generator for generating a read clock signal used to latch read data from the one or more receive elements into the memory controller. The read clock signal generator generates the read clock signal from the memory clock signal or from a control signal representative of the memory clock signal. Each of the memory modules, in an embodiment, is a synchronous dynamic random access memory module.

In one embodiment, the controller generates the read clock signal by receiving the memory clock signal from at least one memory module. The controller transmits the memory clock signal to the at least one memory module and receives, via a serial connection, the memory clock signal from the at least one memory module. The received memory clock signal generally becomes the read clock signal, wherein the read clock signal is delayed from the memory clock signal due to environmental conditions. However, the received read data is also delayed due to said environmental conditions, such that the received read clock signal is aligned with the read data.

In another embodiment, the controller generates the read clock signal from a control signal. The control signal is drawn from the memory clock signal generator such that drawn control signal is substantially similar to the memory clock signal. In this case, the control signal is delayed by a delay compensation element a predetermined time period to generate the read clock signal. Consequently, the read clock signal is delayed compared to the memory clock signal. In one embodiment, the delay compensation element is a capacitor and the predetermined time period relates to environmental conditions, such as printed circuit board trace lengths of read lines transmitting read data from the at least one memory module to the controller.

A more complete appreciation of the present invention and its improvements can be obtained by reference to the accompanying drawings, which are briefly summarized below, to the following detailed description and presently preferred embodiments of the invention, and to the appended claims.

### BRIEF DESCRIPTION OF THE DRAWINGS

FIG. 1 illustrates a disc drive storage media device that incorporates one or more SDRAM modules and a control module according to aspects of an embodiment of the present invention.

FIG. 2 illustrates a system configuration including electronic elements of the disc drive shown in FIG. 1, such as the SDRAM modules and the control module referred to in FIG. 1.

FIG. 3 illustrates an SDRAM control module that derives a read clock signal from the SDRAM clock signal by feeding the SDRAM clock signal back to the SDRAM control module.

FIG. 4 illustrates an SDRAM control module that derives a read clock signal from the SDRAM clock signal and having a delay compensation element.

FIG. 5 illustrates an exemplary timing diagram of sample signal waveforms for the system shown in FIG. 4.

FIG. 6 illustrates a flow chart of functional operations related to generating a read clock signal according to an embodiment of the present invention.

FIG. 7 illustrates a flow chart of functional operations related to a particular embodiment of the present invention.

FIG. 8 illustrates a flow chart of functional operations related to another embodiment of the present invention.

### DETAILED DESCRIPTION

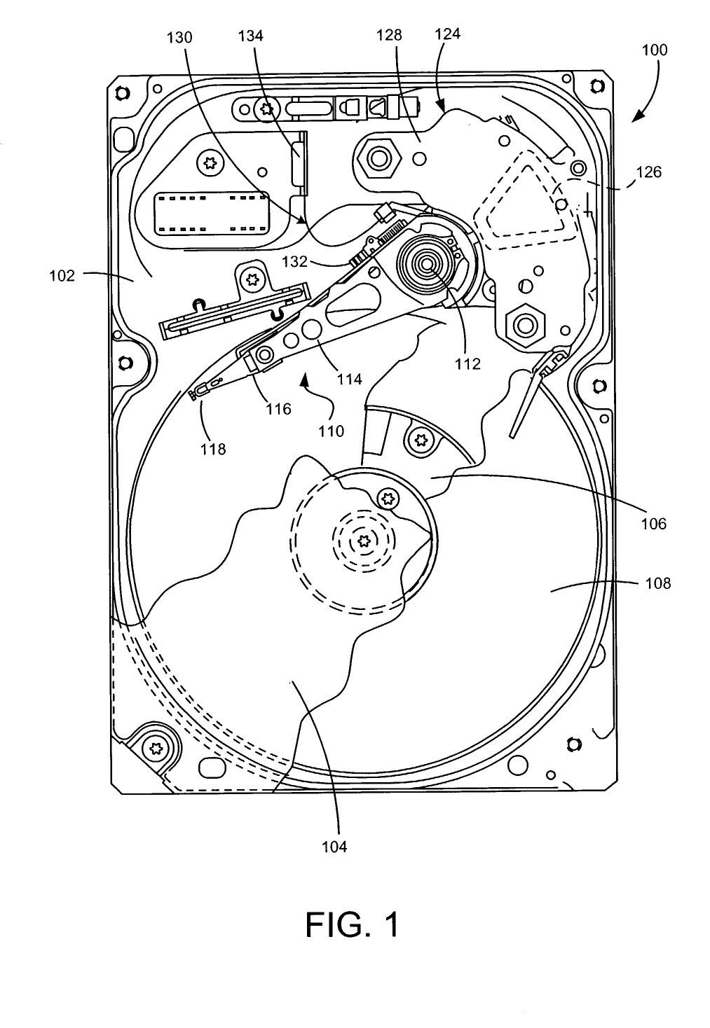

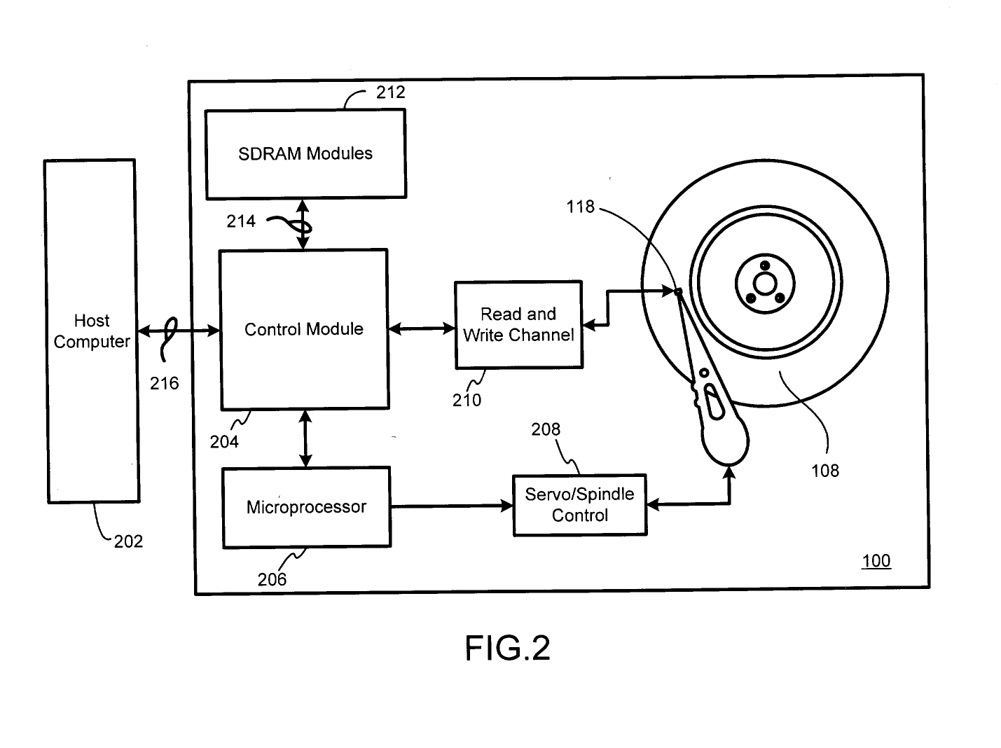

In general, the present disclosure describes a system and method for controlling the timing of a clock signal and control signals to be conducted to an SDRAM module in a system with a relatively high-speed system clock. A disc drive device 100 that may incorporate aspects of the present invention is shown in FIG. 1. It should be understood that other environments which use SDRAM modules, such as other computing environments, are contemplated and may be within the scope of the present invention. Hence, FIGS. 1 and 2 and related descriptions are intended to provide a background environment in which the present invention may be practiced.

In an embodiment, the disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to move or fly in close proximity above the corresponding surface of the associated disc 108.

During operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones (not shown) near the inner diameter of the discs 108 when the drive motor is de-energized. The heads 118 are secured over the park zones through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base 102 to a disc drive printed circuit board (not shown) mounted to the bottom side of the disc drive 100. The printed circuit board 132 is used to connect the disc drive 100 to a host computer system and control many of the functional operations of the disc drive 100.

Referring now to FIG. 2, shown therein is a functional block diagram of the disc drive 100 of FIG. 1, generally showing the main functional circuits which are typically resident on a disc drive printed circuit board 132 and which are used to control the operation of the disc drive 100. As shown in FIG. 2, a host computer 202 is operably connected to an interface application specific integrated circuit or control module 204 via both control lines and data lines. A microprocessor 206 is operably connected to the module 204 and provides top level communication and control for the disc drive 100. Programming for the microprocessor 206 is typically stored in a microprocessor memory (not shown). Additionally, the microprocessor 206 provides control signals for servo and spindle control 208.

Data to be written to the disc drive 100 is passed from the host 202 to the control module 204 and then to a read/write channel 210, which encodes and serializes the data. The read/write channel 210 also provides the requisite write current signals to the heads 118. To retrieve data that has been previously stored by the disc drive 100, read signals are generated by the heads 118 and provided to the read/write channel 210, which processes and outputs the retrieved data to the interface control module 204 for subsequent transfer to the host 202. Such previously described operations of the disc drive 100 are well known in the art and are discussed, for example, in U.S. Pat. No. 5,276,662 issued Jan. 4, 1994 to Shaver et al.

In accordance with the present invention, the system 100 also includes one or more memory modules or buffer 212. In one embodiment the memory modules 212 are synchronized dynamic random access memory (SDRAM) modules. The control module 204 manages the memory 212 in response to commands received from the host 202, as discussed below. The memory buffer 212 facilitates high speed data transfer between the host 202 and the disc drive 100 and may be used to temporarily store data that is to be transferred either to the disc media 108 or to the host 202.

The control module 204, also referred to as the “controller,” operates in conjunction with a system clock (not shown). The system clock has a predetermined frequency, i.e., the time between rising edges of the clock signal. The control module 204, therefore, receives a clock signal and uses it to control the timing of its operations, including the latching of data and control signals onto connection lines 214 to and from the SDRAM modules 212 in relation to the system clock frequency.

Each SDRAM module 212 has predetermined timing requirements related to setup and hold times by which the data on various address and data control lines 214 must be stable. The setup and hold times are determined from the rising edge of the clock signal conducted to the SDRAM module by the controller 202. Thus, the controller 214 must adhere to these requirements, regardless of the speed of the system clock, in order to satisfy the requirements of the SDRAM modules. The controller 204 provides memory clock signals so as to satisfy these requirements for a relatively fast system clock.

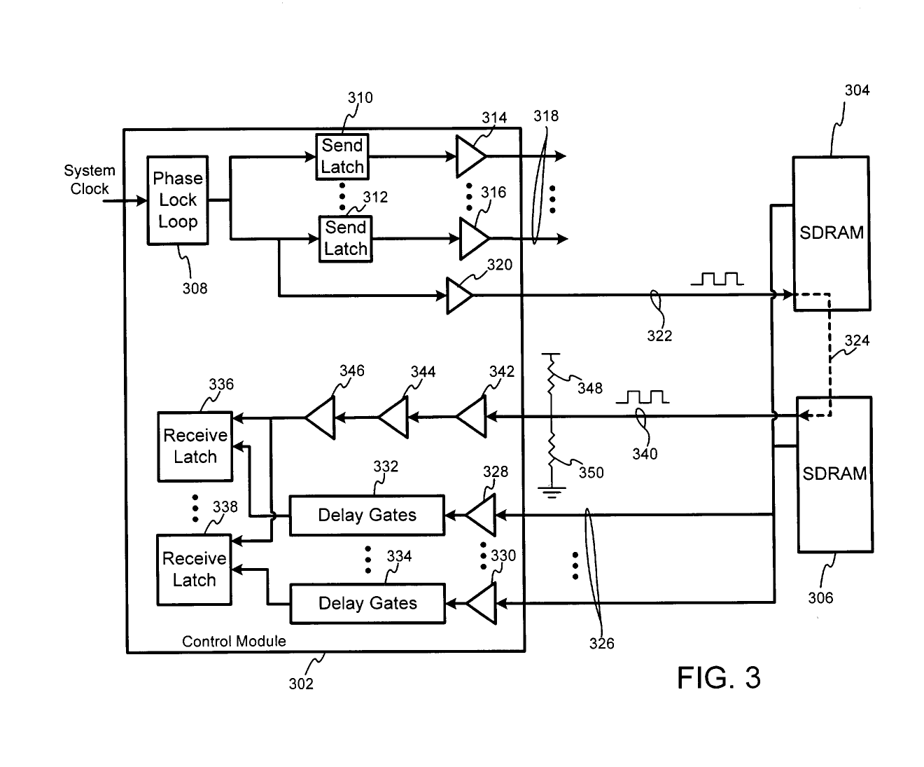

FIG. 3 illustrates a block diagram of a controller 302, and some of its components used in controlling the timing of clock and data signals conducted to SDRAM modules 304 and 306. In comparing FIG. 3 to FIG. 2, the controller 204 (FIG. 2) is essentially the controller 302 (FIG. 3) and the SDRAM modules 212 (FIG. 2) correspond to SDRAM modules 304 and 306 (FIG. 3).

As shown in FIG. 3, the controller 302 has a phase lock loop module 308 that receives the system clock signal and uses the system clock signal to generate a new clock signal, i.e., an internal signal to be used to control internal components. Consequently, the new clock signal is related to the original system clock signal and typically has the same frequency. Although shown as a phase lock loop module, other clock generation modules may be used. The phase lock loop module 308 conducts a clock signal to data and control latches 310 and 312. The latches 310 and 312 exemplify the latches used by the controller in receiving data and address values from another module, such as microprocessor 206 or a host 202 (FIG. 2). Typically, the controller 302 provides many address and data control signals. For example, in one embodiment fifty-three different control values are managed by controller 302 such that there may be over fifty different latches, exemplified by 310 and 312, in the controller 302. The phase lock loop 308 therefore provides the clock signal that latches these different control values into the controller 302. Once latched, the output signal of each latch such as 310 and 312 is buffered, such as through I/O buffers 314 and 316, onto control lines 318, which, although not shown, are connected to the SDRAM modules 304 and 306. The I/O buffers may be used to raise the voltage level of the signal to a predetermined level in order for the SDRAM modules to differentiate between various signals. Additionally, the I/O buffers 314 and 316 introduce a delay between the time in which a signal is provided to each buffer and the time the signal is available at the output of the buffer.

The controller 302 also incorporates a clock buffer 320 that buffers an SDRAM clock signal 322. The clock buffer 320 provides the SDRAM clock signal 322 to both the SDRAM module 304 and the SDRAM module 306 to control the timing of the SDRAM module. In essence, the SDRAM modules 304 and 306 operate in relation to the rising edge of the incoming SDRAM clock signal 322. Consequently, the phase lock loop portion 308 and the buffer 320 form a memory module clock signal generator that generates the memory clock signal. In an embodiment, the buffer 320 is substantially similar to the buffers 314 and 316. As such, differences due to process, voltage and temperature are minimized. The use of the clock buffer 320 and the benefits of such are discussed in more detail in US Patent Application Serial No ______, (Attorney Docket No. STL10512/MG40046.184USU1), titled “METHOD AND SYSTEM FOR CONTROLLING CLOCK SIGNALS IN A MEMORY CONTROLLER,” filed concurrently herewith, which is assigned to the assignee of the present application, and which is incorporated herein by reference for all that it discloses and teaches. Other embodiments, however, may generate the SDRAM clock signal in other methods, such as by drawing a clock signal from the clock fan out tree near buffer 316.

In the embodiment shown in FIG. 3, the SDRAM clock signal 322 is provided to both SDRAM modules in a serial manner as indicated by the dashed line 324. Using this clock signal 322 the SDRAM modules recognize when to latch information from data and control lines 318 or to place information on read lines 326. The read lines 326 relate to connection lines used for conducting bits of information from the memory modules 304 and 306 to the controller 302. Although only two lines are shown in FIG. 3, many more lines may be present, e.g., up to 32 separate lines in many embodiments. As is known, the information on the read lines is generally buffered by receive elements within the controller 302, such as by buffers 328 and 330 to ensure proper voltage levels for the controller 302. Typically a separate buffer exists for each of the different read lines. Delay gates 332 and 334 may also be incorporated into the signal path for reasons discussed below. Eventually, the information from the read lines 326 is conducted to latches, such as latches 336 and 338 to be used by the controller, wherein a separate latch is typically present for each separate read line. Upon latching the information, the read information is typically passed to the host system, such as system 202 (FIG. 2) for use.

The timing of the latches 336 and 338 is controlled by a clocked control signal, i.e., a read clock signal 340. Consequently, a read clock signal must be generated and used to latch the information into the controller 302, and as such, the controller has or uses a read clock signal generator for generating the read clock signal. In the embodiment shown in FIG. 3, the read clock signal 340 is generated by feeding or transmitting the SDRAM clock control signal 322 from the SDRAM modules 304 and 306 back to the controller 302. In essence, the serially connected clock conduction line is traced back to the controller 302. The signal 340 is passed through a series of buffers 342, 344 and 346 to the latches 336 and 338. The signal 340 triggers the latches 336 and 338 to transfer the information from the associated read lines 326 into each latch. Also, the system shown in FIG. 3 includes resistors 348 and 350 as a voltage divider to terminate and maintain the voltage level of the clock signal 340.

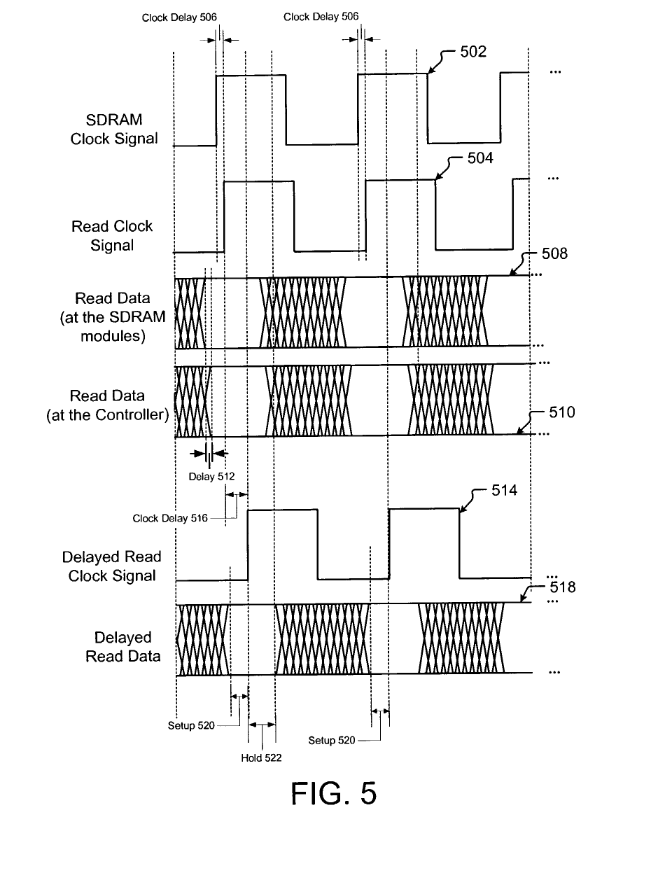

Generating the clock signal by feeding the SDRAM clock signal back to the controller 302 provides the controller 302 with a precise understanding of when the rising edge of the SDRAM clock signal reached the SDRAM modules 304 and 306. That is, since the same clock signal is conducted back to the controller 302, then the differences in timing relate primarily to the PCB trace lengths and variances due to process, voltage and temperature (PVT) of the conduction line. However, since the read lines 326 share many of the same environmental conditions, such as PVT and relatively similar PCB trace length, the signals on the read lines are generally aligned with the signal 340 as discussed in more detail below in conjunction with FIG. 5. Consequently, the read control signal 340 provides the necessary timing information to adequately determine when to latch the information from the read lines into the latches 336 and 338.

The information on the read lines is ready to be latched a predetermined time following a rising edge of the SDRAM clock. That is, the SDRAM modules 304 and 306 typically indicate and often guarantee the predetermined time between receiving a rising edge of the SDRAM clock signal and when the information on the read lines 326 is stable and ready to be latched into the controller 302. For example, many SDRAM modules guarantee that approximately four nanoseconds following receipt of the rising edge of the SDRAM clock signal, the SDRAM module will transmit the read signals in a stable manner on the read lines. Delay elements 344 and 346 represent the delay that occurs in the read clock due to a read clock fan-out structure. That is, the read clock 340 must be provided to numerous read latches, such as 336 and 338 and in some implementations, 32 such latches are used to read data. In such a case, creating 32 copies of the read clock 340 using the clock fan-out structure, represented by 344 and 346, causes some delays to occur between when the read clock signal 340 arrives at the controller boundary and when the actual control signals arrive at the latch elements 336 and 338, wherein the control signals control when the latch functions actually occur. The other buffer, buffer 342, may be used to match the delay associated with other incoming buffers 328 and 330. Additional delays in the read data path 326 relating to PVT and PCB trace lengths, as discussed above, are compensated for by feeding the read clock signal 340 back from the SDRAM modules 304 and 306.

Compensating for the inherent delay in the clock signal as it passes through elements 344 and 346 may be further optimized by inserting delay gates 332 and 334 in the data paths of the read lines 326. Providing the delay gates 332 and 334 ensures the hold time requirements on the input latches 336 and 338 are met under best case conditions while concurrently meeting setup requirements under the worst-case conditions. By using delay elements 332 and 334 to substantially match the delay in elements 344 and 346, the timing relationship of the data to the clock 340 that existed at the controller device boundary is preserved through the entire path from the I/O buffers, such as buffers 328, 330 and 342 to the read latches, such as latches 336 and 338, over PVT, as the substantially matched delays in these paths will be effected equally by the changes in PVT. Consequently, an embodiment of this invention provides a method of substantially matching the external delays between the SDRAM modules 304 and 306 and the controller chip 302, and also provides a method of substantially matching the internal delays between the read clock 340 and the data paths within the controller device 302.

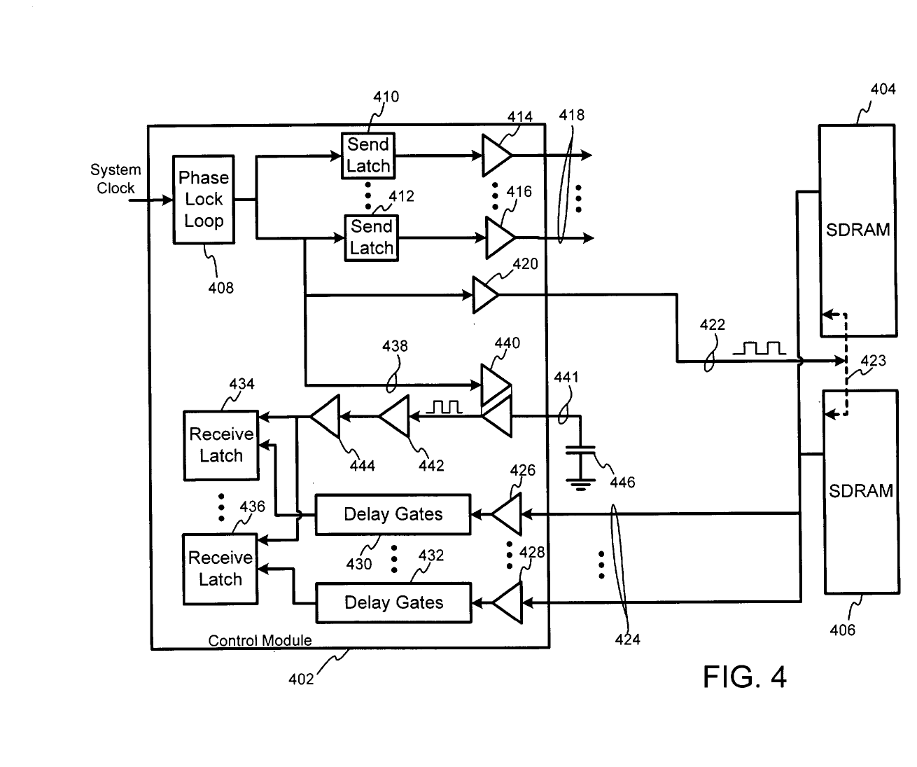

Another embodiment of the present invention is shown in FIG. 4. Controller 402 is used to control SDRAM modules 404 and 406. The controller 402 is similar to the controller 302 (FIG. 3) in many ways. For instance, the controller 402 has a phase lock loop module 408 similar to phase lock loop 308 (FIG. 3) that receives the system clock signal and uses the system clock signal to generate a new clock signal, i.e., an internal signal to be used to control internal components. The phase lock loop module 408 also conducts a clock signal to data and control latches, such as latches 410 and 412, which are similar to latches 310 and 312 shown in FIG. 3. Once latched, the output signal of each latch, such as 410 and 412 is buffered, such as through I/O buffers 414 and 416, onto control lines 418, which, although not shown, are connected to the SDRAM modules 404 and 406.

The controller 402 also incorporates a clock buffer 420 that buffers an SDRAM clock signal 422. The clock buffer 420 provides the SDRAM clock signal 422 to both the SDRAM module 404 and the SDRAM module 406 to control the timing of the SDRAM module. In essence, the SDRAM modules 404 and 406 operate in relation to the rising edge of the incoming SDRAM clock signal 422. In an embodiment, the buffer 420 is substantially similar to the buffers 414 and 416. The use of the clock buffer 420 and the benefits of such are discussed in more detail in copending US Patent Application Serial No. ______, (Attorney Docket No. STL10512/MG40046.184USU1), titled “METHOD AND SYSTEM FOR CONTROLLING CLOCK SIGNALS IN A MEMORY CONTROLLER,” filed concurrently herewith, which is assigned to the assignee of the present application, and which is incorporated above by reference. As discussed above however, alternative embodiments may generate the SDRAM clock signal in other methods, such as by drawing a clock signal from the clock fan out tree, e.g., near buffer 416.

In the embodiment shown in FIG. 4, the SDRAM clock signal 422 is provided to both SDRAM modules in a non-serial manner as indicated by the dashed line 423. Using this clock signal the SDRAM modules recognize when to latch information from data and control lines 418 or to place information on read lines 424, which are similar to read lines 326 shown and described above in conjunction with FIG. 3. Buffers 426 and 428 ensure proper voltage levels for the controller 402 and, typically, a separate buffer exists for each of the different read lines 424. Delay gates 430 and 432 may also be incorporated into the data path. Eventually, the information from the read lines 424 is conducted to latches, such as latches 434 and 436 to be used by the controller, wherein a separate latch is typically present for each separate read line. Upon latching the information, the read information is typically passed to the host system, such as system 202 (FIG. 2) for use.

The timing of the latches 434 and 436 is controlled by a clocked control signal, i.e., a clock signal 441. As stated above, the controller 402 uses a read clock generator to generate the read clock signal. In the embodiment shown in FIG. 4, the read clock signal 441 is generated by conducting a clock signal 438, drawn from the phase lock loop 408 to a buffer 440 internal to the controller 402. Consequently, the read clock signal generator in this embodiment relates to the phase lock loop portion 408 and the buffer 440 wherein the clock signal 438 is similar to the clock signal conducted to the clock buffer 420. Additionally, the buffer 440 has substantially the same characteristics as the clock buffer 420. Therefore, the read clock signal 441 transmitted from the buffer 440 has similar timing characteristics of the SDRAM clock control signal 422 transmitted to the SDRAM module. In particular, the timing of the rising edge of the clock signals 422 and 441 are relatively aligned as shown and discussed below in conjunction with FIG. 5. The signal 441 is passed through a series of other buffers, such as buffers 442 and 444, representing a read-clock fan-out tree that duplicates the read clock signal and propagates the same to the various latches, e.g., to the latches 434 and 436. The delayed read clock signal, i.e., the signal transmitted from buffer 444 is then used to trigger the latches 434 and 436 to transfer the information from the associated read lines 424 into each respective latch.

Importantly, the embodiment shown in FIG. 4 also incorporates another delay compensation element 446. As shown, the delay element 446 may be a capacitor 446. The delay compensation element 446 is designed to compensate for differences in timing related to PCB trace lengths and known variances due to PVT. The delay element injects a small delay in clock signal 441 so that the clock signal 441 will substantially match the timing of the SDRAM clock signal as it reaches the SDRAM modules. Further, the delay element 446 may also delay the clock signal 438 to compensate for PCB trace lengths in the read lines 424 related to the timing delays in transmitting signals back to the controller 402.

In an embodiment, delay gates 430 and 432 are chosen to substantially match the inherent delays associated with this read clock fan-out structure or tree such that the read path signals arrive at the latches 434 and 436 in a manner that preserves the timing relationship between the data and the clock, i.e., the relationship of these signals at the controller boundary is substantially preserved until reaching the latches 434 and 436. Substantially preserving this relationship ensures that the data arrives at the latches 434 and 436 with the same setup and hold characteristics to the read clock that existed at the SDRAM modules 404 and 406. In an alternative embodiment, the delay elements 430 and 432 may be chosen to adjust the relative timing relationships between the data path signals and the read clock to “center” the data based on the setup and hold characteristics of the read latches 434 and 436.

The embodiment shown in FIG. 4 is similar to the embodiment shown in FIG. 3 in that the read clock signal is generated using the SDRAM clock signal. In one case (FIG. 3), the SDRAM clock signal is fed back to the controller 302. In the other case (FIG. 4), the same clock signal used to drive the clock buffer 420 is also used to drive a read clock buffer 440, wherein the two buffers 420 and 440 are substantially similar. Both embodiments account for delays in the read line information by either conducting the clock signal along a similarly inhibiting line (FIG. 3) or by incorporating a delay compensation element 446 (FIG. 4). In both cases, a read clock signal is generated that approximates the specific timing of the SDRAM clock signal and thus the timing of the read lines to ensure stability in the data when latched into controller buffers.

FIG. 5 illustrates sample signal waveforms that may be created and used according to the present invention. The waveforms shown in FIG. 5 may be created by either of the control modules 302 and 402 shown and described above in conjunction with FIGS. 3 and 4 respectively. As discussed above, the present invention relates to the creation of an SDRAM clock signal, such as signal 502 shown in FIG. 5. The SDRAM clock signal is conducted to the SDRAM modules 212 (FIG. 2), also illustrated by modules 304 and 306 (FIG. 3) and 404 and 406 (FIG. 4).

In addition to the SDRAM clock signal 502, embodiments of the present invention generate a read clock signal, such as signal 504. The read clock signal 504 relates to signals 340 sampled at the controller and/or signal 441 sampled at the output of buffer 440 shown and described above in conjunction with FIGS. 3 and 4, respectively. Both signals 502 and 504 are repeating clock pulses used to control other components in the system. Further, both signals 502 and 504 are based in part on the system clock signal (not shown) received from the host computer system 202 (FIG. 2).

In an embodiment, the read clock signal 504 is a delayed version of the SDRAM clock signal, as indicated by clock delay 506. The clock delay 506 represents delays in receiving the clock signal back from the SDRAM modules in the embodiment shown and described in FIG. 3 and also simulates the delays injected in the read lines due to PCB trace lengths and other PVT conditions as information is transmitted from the SDRAM modules to the controller. Similarly, with respect to the embodiment shown in FIG. 4, the delay 506 also represents the delays associated with transmitting the read data back to the controller. However, with respect to the embodiment shown in FIG. 4, the delay 506 is created by the delay compensation element 446. Consequently, although the SDRAM clock signal 502 and the read clock signal 504 are relatively aligned, a small delay 506 is injected in the read clock signal 504. Based on different variance conditions, such as temperature, voltage, trace lengths, etc., the actual delay 506 may vary. However, the delay 506 tracks similar delays in the read data.

FIG. 5 also illustrates waveform signals 508 and 510 representing the read data lines, such as signals present on read lines 326 and 424 (FIGS. 3 and 4 respectively). Waveform 508 relates to the read data sampled near the SDRAM modules. Consequently, the timing of the read data 508 corresponds to the SDRAM clock signal 502. That is, the data on the read lines represented by waveform 508 is stable for a predetermined time following the rising edge of the SDRAM clock signal 502, e.g., four nanoseconds, and held stable for a predetermined time, e.g., three nanoseconds. Waveform 510, on the other hand relates to the read data sampled near the controller. As such, the read line information 510 is delayed compared to the read data 508, wherein the delay is represented by delay 512. The delay 512 is caused by the transmission time in conducting read data from the SDRAM modules to the controller.

In an embodiment, the delay 512 relating to the read data delay is substantially the same as the clock delay 506 between the SDRAM clock signal 502 and the read clock signal 504. Therefore, the system recognizes, using the read clock signal 504, the time, which the read data 510 is stable such that it can be latched into the controller. In a particular embodiment, to account for best and worst case conditions, the read clock signal 504 is delayed to ensure the latch operation occurs when the read data is stable. Consequently, the system produces a delayed read clock signal 514, which is delayed from the read clock signal 504 by delay 516. Furthermore, the read data itself may be delayed prior to latch time resulting in delayed read data waveform 518. Delay 516, therefore, is designed to achieve proper setup time 522 and hold time 524 to adequately latch the read data 518 into controller latches.

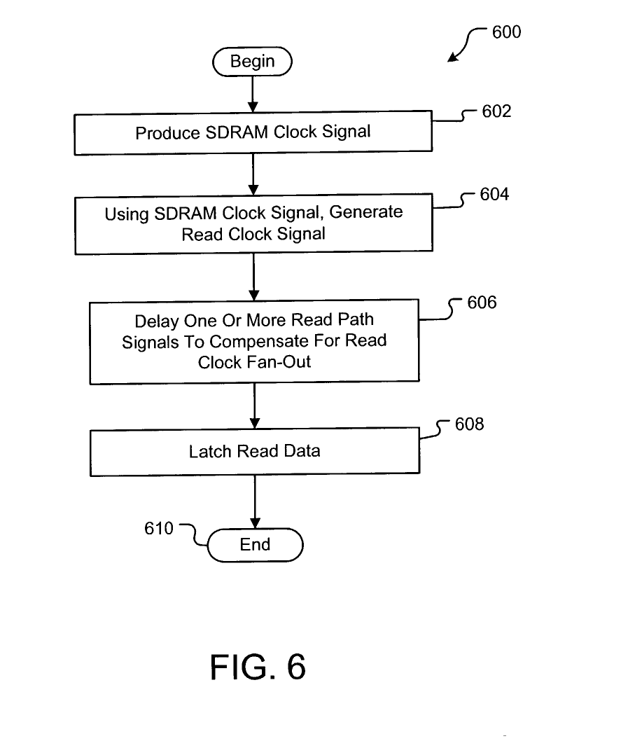

FIG. 6 illustrates the functional components of an embodiment of the present invention. The flow 600 relates to the generation of a read clock signal to be used in latching read data into controller latches, such as latches 336 and 338 or 434 and 436. Flow 600 begins with produce operation 602 which produces an SDRAM clock signal. The production of such a clock signal may be done in numerous ways. For instance, the SDRAM clock signal may be drawn from the PLL as shown in FIGS. 3 and 4 before latches 310 and 312 or latches 410 and 412. Alternatively, the SDRAM clock signal may be drawn from the clock fan out tree following the latches 310 and 312 or latches 410 and 412. The SDRAM clock signal is transmitted to the SDRAM modules.

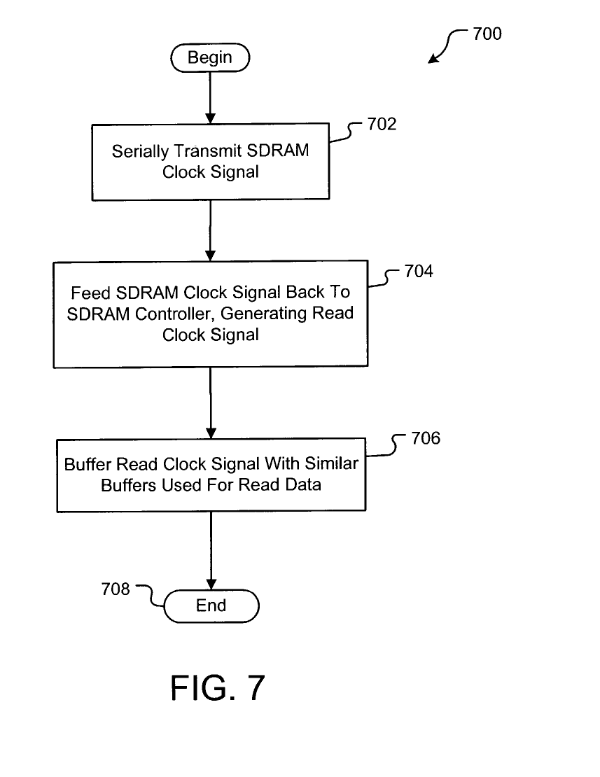

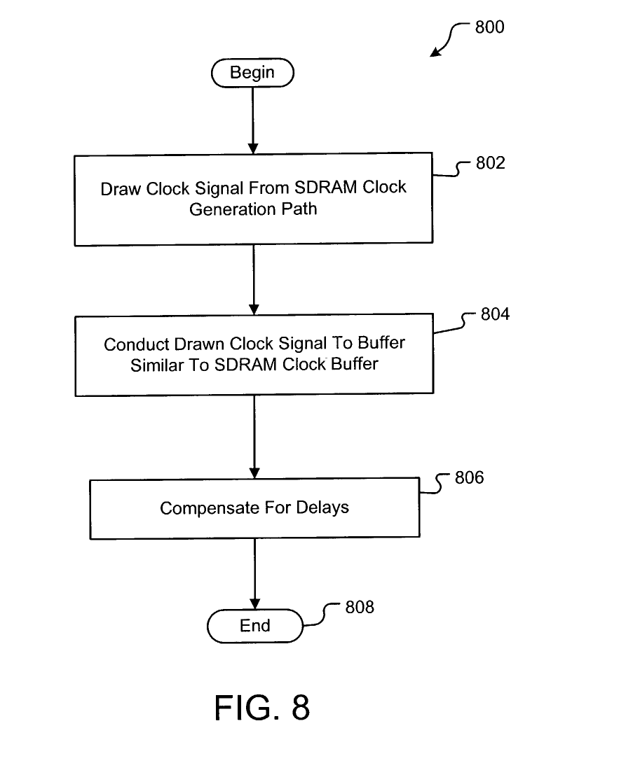

Upon producing the SDRAM clock signal, generate operation 604 generates a read clock signal. The read clock signal represents the timing of the SDRAM clock signal, including some delays to compensate for variations in sending the SDRAM clock signal and receiving read data from the SDRAM modules. The generation of the read clock signal may be achieved in different ways, as discussed below in conjunction with FIGS. 7 and 8. However, the read clock is generated in a manner that preserves the timing relationship between the SDRAM clock signal at the SDRAM modules and the read path data signals, at the SDRAM modules, such that the read clock signal at the controller boundary occurs at a predetermined time with respect to when the read-path data arrives, as determined by the setup and hold time specifications of the SDRAM modules.

Following the creation of the read clock signal, delay operation 606 delays one or more read-path signals for predetermined period(s) of time. That is once the read data arrives on the data pins of the controller, the data is buffered and transmitted to the read latches. However, since the generated read clock (operation 604) is later duplicated and propagated through a read-clock fan-out tree to the various latches, some delays in the various read clock signals inherently occur between arrival at the controller and reaching the actual read latches. Delay operation 606 compensates for these delays and maintains the timing relationship between the read clock signal and the data signals as of when the signals arrive at the controller.

Next, using the delayed read clock signal, the read data is latched into the controller at operation 608. Upon latching the information may be used by the host system, such as system 202 (FIG. 2). Following latch operation 608, flow 600 ends at end operation 610.

FIG. 7 illustrates the functional components related to generating a read clock signal, such as signal 504 (FIG. 5) in a particular embodiment of the present invention. In this embodiment, the system incorporates a plurality of SDRAM modules, such as modules 304 and 306 shown in FIG. 3. Flow 700 begins with transmit operation 702 which serially transmits the clock signals to the SDRAM modules. An example of a serial connection allowing such a transmission is illustrated in FIG. 3. The serial connection of the clock signal lines further comprises serially connecting the clock signal back to the controller, also as shown in FIG. 3.

Following transmit operation 702, feed operation feeds the SDRAM clock signal back to the SDRAM controller. Feeding the clock signal back to the controller may be accomplished using the serial connection shown in FIG. 3. Feeding the SDRAM clock signal back to the controller essentially generates a read clock signal. Since the SDRAM clock signal is subjected to environmental conditions such as those related to PVT and/or PCB trace lengths, the actual read clock signal may be delayed from the SDRAM clock signal (as sampled at the SDRAM modules).

Next, buffer operation buffers the read clock signal into the controller. In one embodiment the buffer operation uses a buffer component similar to the buffer components used to buffer incoming read data to ensure known delays that track over PVT. Once buffered, flow 700 ends at end operation 708.

FIG. 8 illustrates the functional components related to generating a read clock signal, such as signal 504 (FIG. 5) in a particular embodiment of the present invention. In this embodiment, the system incorporates one or more SDRAM modules, such as modules 404 and 406 shown in FIG. 4. Flow 800 begins with draw operation 802, which draws a clock signal from the SDRAM clock generation path. In essence, an SDRAM clock signal is generated within a controller, such as controller 402 shown in FIG. 4. Draw operation 802, in this embodiment, draws a clock signal internally from the SDRAM clock signal and transmits the signal to the receive path to create a read clock signal.

In a particular embodiment, draw operation draws the clock signal prior to an SDRAM clock output buffer as shown and described above in conjunction with FIG. 4. As such, conduct operation 804 conducts the drawn clock signal to a similar buffer to maintain timing similarity between the SDRAM clock signal and the generated read clock signal. In this case, the read clock signal relates to the clock signal produced by the buffer.

Additionally, in order to compensate for delays associated with sending the SDRAM clock to the SDRAM modules and delays related to other environmental conditions such as those related to PVT and/or PCB trace lengths, the actual read clock signal may be delayed from the SDRAM clock signal (as sampled at the SDRAM modules). Compensate operation 806 compensates for these delays. In one embodiment, the compensation operation 806 involves using a capacitor to delay the read clock signal as shown and described in conjunction with FIG. 4. Other delay compensation schemes can be used. Upon delaying the read clock signal, flow 800 ends at end operation 808.

The benefits of embodiments described above related to generating a read clock signal that is aligned with SDRAM clock signal are many. For instance, since the read clock signal begins either at the SDRAM modules (FIG. 3) or at a predetermined buffer (FIG. 4), and not the phase lock loop, the delays associated with the read data path and the read clock signal vary almost identically with PVT and PCB trace lengths. Accordingly, the above-described invention may be viewed as a memory controller (such as controllers 302 or 402) having one or more receive elements (such as elements 328 and 330 or 426 and 428) operably connected to the at least one memory modules (such as modules 304 and 306 or 404 and 406) for receiving read data from the at least one memory modules. Additionally, the controller also has a memory clock signal generator (such as 408 and 420) for generating a clock signal to control timing characteristics of the at least one memory module and a read clock signal generator (such as 342 or 440) for generating a read clock signal used to latch read data from the one or more receive elements into the memory controller. The read clock signal generator generates the read clock signal from the memory clock signal or from a control signal representative of the memory clock signal. Each of the memory modules, in an embodiment, is a synchronous dynamic random access memory module.

In one embodiment, the controller generates the read clock signal by receiving the memory clock signal (such as 340) from at least one memory module (as shown in FIG. 3). The controller transmits the memory clock signal to the at least one memory module and receives, via a serial connection, the memory clock signal from the at least one memory module. The received memory clock signal generally becomes the read clock signal, wherein the read clock signal is delayed from the memory clock signal due to environmental conditions. However, the received read data is also delayed due to said environmental conditions, such that the received read clock signal is aligned with the read data.

In another embodiment, the controller generates the read clock signal (such as 441) from a control signal (such as 438). The control signal is drawn from the memory clock signal generator such that drawn control signal is substantially similar to the memory clock signal. In this case, the control signal is delayed by a delay compensation element a predetermined time period to generate the read clock signal. Consequently, the read clock signal is delayed compared to the memory clock signal. In one embodiment, the delay compensation element is a capacitor and the predetermined time period relates to environmental conditions, such as printed circuit board trace lengths of read lines transmitting read data from the at least one memory module to the controller.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A memory controller for latching information from at least one memory module, the controller comprising:
at least one receive element operably connected to the at least one memory module for receiving read data from the at least one memory module;
a memory clock signal generator for generating a clock signal to control timing characteristics of the at least one memory module; and
a read clock signal generator for generating a read clock signal used to latch read data from the at least one receive element into the memory controller, wherein the read clock signal generator generates the read clock signal from the memory clock signal.

2. A controller as defined in claim 1 wherein the read clock signal generator generates the read clock signal by receiving the memory clock signal from at least one memory module.

3. A controller as defined in claim 2 wherein the controller transmits the memory clock signal to the at least one memory module and receives, via a serial connection, the memory clock signal from the at least one memory module and wherein each of the at least one memory modules is a synchronous dynamic random access memory module.

4. A controller as defined in claim 3 wherein the received memory clock signal relates to the read clock signal and wherein the read clock signal is delayed from the memory clock signal due to environmental conditions.

5. A controller as defined in claim 4 wherein the received read data is delayed due to said environmental conditions.

6. A controller as defined in claim 4 wherein the received read clock signal is aligned with the read data.

7. A controller as defined in claim 1 wherein the read clock signal generator generates the read clock signal by drawing a control signal from the memory clock signal generator such that drawn control signal is substantially similar to the memory clock signal.

8. A controller as defined in claim 7 further comprising:
a delay compensation element, the delay compensation element delaying the drawn clock signal a predetermined time period to generate the read clock signal and wherein the read clock signal is delayed compared to the memory clock signal.

9. A controller as defined in claim 8 wherein the delay compensation element is a capacitor.

10. A controller as defined in claim 9 wherein the predetermined time period relates to environmental conditions.

11. A controller as defined in claim 10 wherein the environmental conditions relate to printed circuit board trace lengths of read lines transmitting read data from the at least one memory module to the controller.

12. A controller as defined in claim 1 further comprising:
latch elements for latching data from the memory modules into the controller;
a read clock fan-out structure for duplicating the read clock signal and supplying control signals to the latch elements, wherein the fan-out structure introduces delays in the control signals; and
one or more delay elements in one or more data paths, the one or more delay elements preserving the timing relationship between the read clock signals and the data path signals across the fan-out structure.

13. A method of controlling the timing of a read clock signal used to latch read data from at least one synchronous dynamic random access memory module into one or more latches, the method comprising:
generating a memory clock signal;
transmitting the memory clock signal to the at least one memory module to initiate a read operation;
receiving a control signal representing the memory clock signal;
generating a read clock signal from the control signal;
delaying the control signal a predetermined time period to account for environmental conditions; and
generating a read clock signal from the delayed control signal.

14. A method as defined in claim 13 wherein the acts of transmitting the memory clock signal to the at least one memory module and receiving a control signal comprises:
serially transmitting the memory clock signal to the memory module and back to a controller for latching read information; and
wherein the act of delaying the control signal a predetermined period of time relates to the delay in transmitting the control signal back to the controller.

15. A method as defined in claim 14 wherein the read clock signal has a predetermined timing relationship with data signals, the predetermined timing relationship based on predetermined setup and hold requirements of the at least one memory module.

16. A method as defined in claim 13 wherein the act of transmitting the memory clock signal comprises buffering a phase lock loop control signal using a memory clock buffer; and wherein the act of receiving a control signal representing the memory clock signal relates to drawing the control signal from the phase lock loop control signal and buffering the drawn signal through a read buffer, the read buffer having substantially similar timing characteristics of the memory clock buffer.

17. A method as defined in claim 16 wherein the act of delaying the control signal comprises triggering the read clock buffer using a capacitor such that the read clock signal is delayed from the memory clock signal.

18. A method as defined in claim 13 further comprising: creating a plurality of latch control signals from the read clock signal;
propagating the latch control signals to read latches, wherein the creation and propagation of the latch control signals introduce one or more predetermined delays; and
delaying one or more data signals to compensate for delays in the latch control signals to maintain the timing relationship between initial read clock signal and the one or more data signals.

19. A disc drive system comprising:
one or more synchronous dynamic random access memory modules for storing information; and
a controller connected to the one or more synchronous dynamic random access memory modules, the controller adapted to,control the timing of a read clock signal in relation to a memory clock signal.

20. A disc drive system as defined in claim 19 further comprising:
a memory clock signal generator for generating the memory clock signal to control timing characteristics of the one or more synchronous dynamic random access memory modules; and
a read clock signal generator means for generating a read clock signal used to latch read data from the one or more receive elements into the memory controller, wherein the read clock signal generator generates the read clock signal from the memory clock signal generator.
